(19) United States
(12) Patent Application Publication
(10) Pub. No.: US 2016/0352922 A1
(43) Pub. Date: Dec. 1, 2016

(54) SIM ACTIVATION AND ATTRIBUTE APPLICATION

(71) Applicant: EPAY LIMITED, Billericay Essex (GB)

(72) Inventor: Priya PATEL, Essex (GB)

(21) Appl. No.: 15/114,893

(22) PCT Filed: Feb. 3, 2015
(86) PCT No.: PCT/EP2015/052179

§ 371 Date: Jul. 28, 2016

(30) Foreign Application Priority Data
Feb. 5, 2014 (GB) 1401936.8

(51) Int. Cl. H04M 15/00; H04M 17/00; H04W 4/24; H04W 8/26

(52) U.S. Cl. CPC H04M 15/715; H04W 8/265; H04M 15/705; H04M 17/103; H04M 17/20; H04W 4/24

(57) ABSTRACT

There is described a technique of enabling a SIM card of a mobile telephone and associating payment value to the SIM card, the method comprising: associating a unique identifier of the SIM card with a unique identifier of the payment value; retrieving an identity of one of the SIM card and a card associated with the payment value at a point-of-sale; transmitting a message including the retrieved identity; responsive to the message, enabling the SIM card and applying the payment value as a credit to the SIM circuit.

### FIELD OF THE INVENTION

The present invention relates to a technique for activating a SIM card and associating an attribution, such as a credit top-up, to an activated SIM card, the SIM card preferably being for use in a pay-as-you-go mobile device.

### BACKGROUND OF THE INVENTION

In a typical prior art arrangement a user may purchase a SIM card for use in a mobile device such as a mobile telephone. The user may purchase a SIM card at a point-of-sale. After the SIM card is purchased, in order to activate the SIM card the user needs to call a specific number. Once the number is called, the SIM card is activated and may be used in a mobile telephone. Typically the SIM card is inserted into the mobile telephone and the number called to activate the SIM card.

In the prior art when such SIM cards are purchased, certain problems arise. Once the SIM card is purchased, it is up to the user to activate it by registration. Unless and until the user effects the activation, the SIM card is unaccounted for post-purchase.

In a typical prior art arrangement, a user may purchase a ‘swipe’ card from a point of sale for use for providing credit to a pay-as-you-go mobile telephone. On purchase of the card it is authorized at the point-of-sale by the retailer swiping the card. The user then calls a number associated with the top-up card to link the card with their mobile telephone. An initial amount of credit may be applied to the mobile telephone associated with an initial value of the top-up card.

The user then purchases additional top-up amounts at points of sale, and any top-up amount is automatically allocated to their mobile phone account through providing the top-up card at the point-of-sale which is swiped by the retailer, and the purchaser's top-up applied to the mobile telephone.

When a user purchases a SIM card and a top-up card at the same time, to activate the SIM card and apply the credit to the mobile telephone using the SIM card the retailer must swipe the top-up card to authorise it, the user must make a telephone call to activate the SIM card, and the user must make a telephone call to link the top-card to the mobile telephone. A user must therefore make two telephone calls, firstly to activate the SIM card and secondly to activate the swipe card.

It is an aim of the present invention to provide an improvement over the prior art.

### SUMMARY OF THE INVENTION

In accordance with the invention there is provided a method of enabling a SIM circuit of a mobile telephone and associating an attribute to the SIM circuit, the method comprising: associating a unique identifier of the SIM circuit with a unique identifier of the attribute; retrieving an identity of one of the SIM circuit and the attribute at a point-of-sale; transmitting a message including the retrieved identity; responsive to the message, enabling the SIM circuit and applying the attribute to the SIM circuit.

Correspondingly, the invention provides a system for enabling a SIM circuit for a mobile telephone and associating an attribute to the SIM circuit, in which system a unique identifier of a SIM card is associated with a unique identifier of the attribute, the system comprising: a point-of sale device for retrieving an identity of one of the SIM circuit and the attribute, and for transmitting a message including the retrieved identity to a network controller; the network controller for enabling, on receipt of the message, the SIM circuit and applying the attribute to the SIM circuit.

Retrieving the identify of one of the SIM circuit and the attribute at the point-of-sale may include retrieving the associated unique identifier.

The message may include an indication of the unique identifier. The message may include the unique identifier.

The step of retrieving the identity of one of the SIM circuit and the attribute at the point-of-sale may include swiping or scanning a device associated with the attribute. The message may include an indication of a unique identifier of a card associated with the attribute.

Responsive to the message the SIM circuit associated with the attribute may be identified, and the SIM circuit is enabled and the attribute applied to the SIM circuit. The message may be transmitted from the point-of-sale, and on enablement of the SIM circuit and application of the attribute a success message is transmitted to the point-of-sale.

The attribute may be a value. A card may identify the attribute. The card may be a top-up card or pay-as-you go card. In general the card may be associated with the value. The card may be a pre-paid card. The SIM circuit may be provided on a SIM card.

The method may further comprise manufacturing a SIM card and value card (such as a top-up card or pre-paid card) pair, and presenting such pair for purchase at the point-of-sale. A housing card or support card may be provided which houses or supports the SIM card.

The invention further provides a service provider entity of a mobile telephony system, in which system a unique identifier of a SIM circuit is associated with a unique identifier of an attribute, the service provider entity adapted to: receive, from a point-of-sale, an identity of a device, associated with the attribute, retrieve at the point-of-sale; forward the identity to an operator; receive, from the operator, confirmation that the SIM circuit associated with the identified attribute is activated, and that the attribute has been applied to the SIM circuit; and forward a confirmation to the point-of-sale.

There is similarly provided a method of enabling a SIM circuit of a mobile telephone and associating a unique identifier of the SIM circuit with a unique identifier of an attribute, the method comprising: receiving, from a point-of-sale, an identity of a device, associated with the attribute, retrieved at the point-of-sale; forwarding the identity to an operator; receiving, from the operator, confirmation that the SIM circuit associated with the identified attribute is activated, and that the attribute has been applied to the SIM circuit; and forwarding a confirmation to the point-of-sale.

There is also provided a method for enabling a SIM circuit of a mobile telephone and associating an attribute to the SIM circuit, the method comprising: linking unique identifiers of a plurality of SIM circuits with unique identifiers of a respective plurality of attributes; manufacturing sets of SIM circuits and attribute devices, a set being determined by the link; offering for sale the manufactured sets of SIM circuits and attribute devices; on purchase of a set, retrieving an attribute identifier of the set at a point-of sale, and transmitting a message including an identification of the attribute identifier to a mobile network entity; retrieving, at the mobile network entity, the identity of the linked SIM circuit in dependence on the identity of the attribute; activating, at the mobile network entity, the SIM circuit; applying, at the mobile network entity, the attribute to the SIM circuit; transmitting a successful completion message from the mobile network entity to the point-of-sale apparatus.

Correspondingly there is provided an apparatus for enabling a SIM circuit of a mobile telephone and associating an attribute to the SIM circuit, wherein unique identifiers of a plurality of SIM circuits are linked with unique identifiers of a respective plurality of attributes, the apparatus comprising: a manufacturer for manufacturing sets of SIM circuits and attribute devices, a set being determined by the link; merchants for offering for sale the manufactured sets of SIM circuits and attribute devices, and on purchase of a set, retrieving an attribute identifier of the set at a point-of sale, and transmitting a message including an identification of the attribute identifier; a mobile network entity for receiving the message including the identification of the attribute identifier, and adapted to: retrieving, at the mobile network entity, the identity of the linked SIM circuit in dependence on the identity of the attribute; activating, at the mobile network entity, the SIM circuit; applying, at the mobile network entity, the attribute to the SIM circuit; and transmitting a successful completion message from the mobile network entity to the point-of-sale apparatus.

In general, the attribute may be associated with a device, and the device may be a card. The attribute may be a value. A card may be associated with the value. The card may be a pre-paid card. When the card is a pre-paid card, the value (or the attribute) may be provided by the credit on the pre-paid card. Part or all of the credit may be applied to the SIM circuit.

When the attribute is provided by a pre-paid card, the pre-paid card is enabled or activated together with the SIM circuit being enabled or activated.

In general, the attribute is a value, and the value and the SIM circuit are each respectively associated with a pre-aid account and a mobile account. The pre-paid account and the mobile account are connected by the association of the unique identifiers, and credit may be transferred from one account to the other using this association.

### BRIEF DESCRIPTION OF THE DRAWINGS

The invention is now described by way of reference to the drawings, in which:

FIG. 1 illustrates a network infrastructure in which embodiments of the invention may be applied;

FIG. 2 illustrates an exemplary process flow which may be implemented in the exemplary architecture of FIG. 1 in accordance with an embodiment;

FIG. 3 illustrates an exemplary packaging in accordance with an embodiment;

FIG. 4 illustrates a modification to the exemplary process of FIG. 2 in accordance with an embodiment; and

FIGS. 5(a) and 5(b) illustrate an exemplary packaging in accordance with the embodiment of FIG. 4.

### DETAILED DESCRIPTION

The invention is described by way of example to an exemplary process provided in an exemplary architecture. One skilled in the art will appreciate that the invention is more broadly applicable than the specific examples given in the following description, and the protection afforded by the invention is defined by the appended claims.

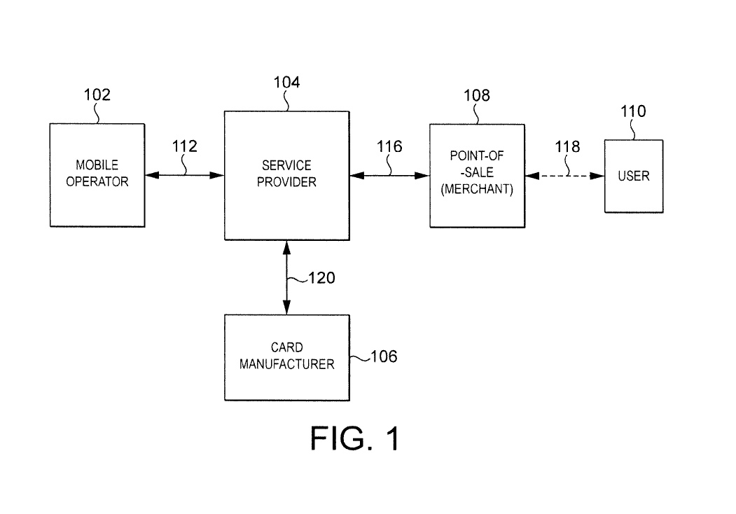

With reference to FIG. 1 there is illustrated an exemplary architecture in which embodiments of the invention may be implemented. The exemplary architecture comprises a mobile operator entity 102, a service provider entity 104, a card manufacturer entity 106, a point-of-sale or merchant entity 108, and a user entity 110.

The mobile operator entity 102 is connected to the service provider entity 104 by electronic communications lines 112, the service provider entity 104 is connected to the point-of-sale entity 108 by electronic communication lines 116, and the point-of-sale entity 108 is connected to the user entity 110 by electronic communication lines 118. The service provider entity 104 is also shown as connected to the card manufacturer 106 by electronic communication lines 120.

A subscriber identity module or subscriber identification module (SIM) is an integrated circuit that securely stores an international mobile subscriber identity (IMSI) and a related key used to identify and authenticate subscribers on mobile telephony devices (such as mobile phones and computers). A SIM circuit is typically embedded into a removable plastic card. This plastic card is called a “SIM card”.

As well as other information, a SIM card contains its own unique serial number (ICCID—integrated circuit card identifier), which uniquely identifies the SIM card and can be used to provide a unique identifier for the SIM card. The other information stored on the SIM card may comprise an international mobile subscriber identity (IMSI), security authentication and ciphering information, temporary information related to the local network, a list of the services the user has access to and two passwords: a personal identification number (PIN) for ordinary use and a personal unblocking code (PUK) for PIN unlocking.

A SIM card can be purchased by a user for use with a mobile telephone device. In particular a user may transfer a SIM card to a mobile telephone which is used with a pay-as-you-go account.

For a pay-as-you-go account, a user must purchase credit to be applied to their mobile telephone, in particular to be applied to the SIM used in their mobile telephone. As noted in the background section above, this involves a user purchasing a pay-as-you-go swipe card which is then subsequently associated with a mobile telephone, to apply credit for use by that mobile telephone.

A swipe card provided for such pay-as-you-go purposes has a unique identifier, so any credit can be uniquely associated with the pay-as-you-go card. A pay-as-you-go swipe card is provided with a unique permanent account number (PAN) which uniquely identifies the card.

The card for providing pay-as-you-go credit may not necessarily be a swipe card with a magnetic strip. For example the card may be provided with a bar-code instead of a magnetic strip. Such a card may be a hybrid card provided with both a magnetic strip and a bar-code. It will be understood that the mechanism which allows for point-of-sale activation may vary, and the essential characteristics for the purposes of this invention is that a unique identifier can be read from the card.

Thus a SIM card can be uniquely identified by an ICCID number, and a pay-as-you-go card can be uniquely identified by a PAN number. Embodiments of the invention utilise these two numbers to uniquely identify the respective cards, but in alternative implementations different numbers may be utilised or specific numbers may be allocated for unique identification. The mechanism for unique identifications of the cards is unimportant, the cards merely needing to be uniquely identified.

For example, a SIM card may be uniquely identified not only by an ICCID, but also by an MSSISDN, an SSN, some combination of all three, or some other unique number.

Similarly the mechanisms for generation of the unique identifiers is outside the scope of the invention. Whilst embodiments of the invention utilise the ICCID and PAN numbers, the generation of these numbers is outside the scope of the invention.

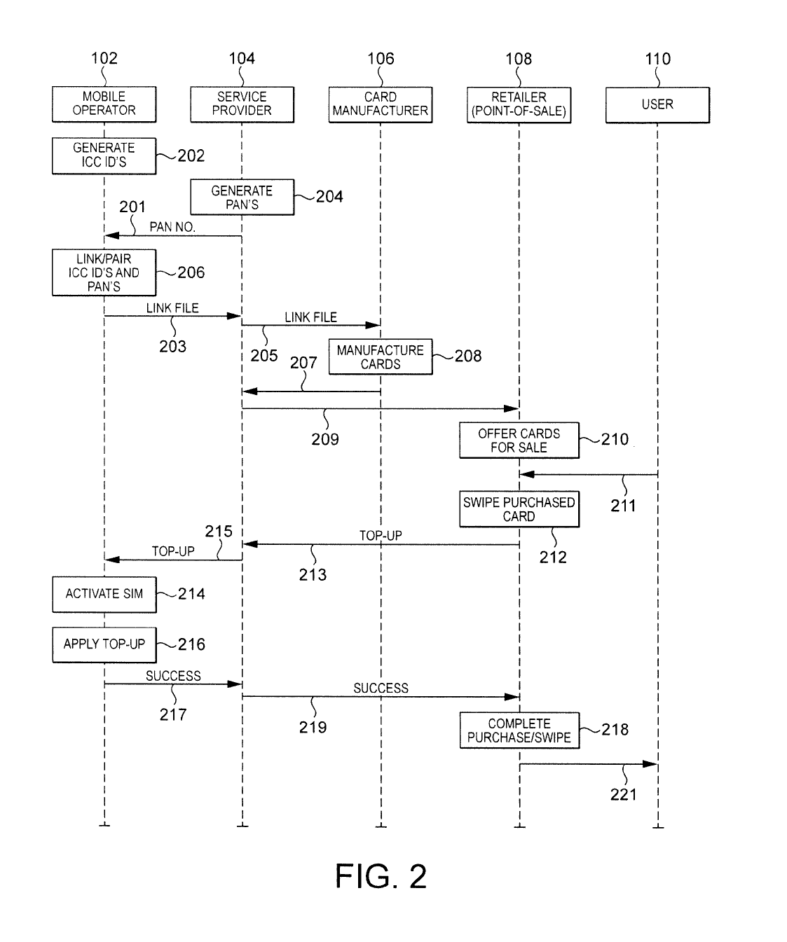

An exemplary process for implementation of the invention is now described further with reference to FIG. 2.

The mobile operator is assumed to ‘own’ the first identifier, i.e. the unique number or identifier allocated to a SIM card which, in the described embodiment, is the ICCID. The mechanism by which the mobile operator acquires or generates the ICCID is outside the scope of this invention. As denoted by step 202 of FIG. 2, the mobile operator has established an ICCID number of a SIM card by some mechanism. In general the SIM card is an example of a SIM circuit, which may be provided in formats other than a card.

The mobile operator, in a described embodiment, is provided with the second identifier, i.e. the unique number or identifier allocated to the pay-as-you-go card or top-up payment card which, in the described embodiment, is the PAN number.

In general a top-up payment card is an example. The top-up payment is an example of an attribute which may be applied to a SIM circuit. The attribute may be another feature applied to the SIM circuit or a mobile account associated with the SIM circuit. The attribute may be provided on a card, such as providing a top-up payment card, or in general on a device. More than one attribute may be associated with a SIM circuit.

The mechanism by which the mobile operator acquires or generates the PAN number is outside the scope of this invention, but in an embodiment the service provider may generate the PAN number and provide the PAN number to the mobile operator. As denoted by step 204 of FIG. 2, the service provider has established a PAN number.

The mobile operator preferably associates each of the first identifiers with one of the second identifiers. This association does not need to be carried out by the mobile operator. For example, the service provider may link the first and second identifiers and notify the mobile operator of the link between the first and second identifiers. However the mobile operator must at least know of the link between the first and second identifiers, and in implementations the association may be conveniently carried out by the mobile operator.

The mobile operator and the service provider can be considered to each be a network controller or part of a network controller.

In the described embodiment, the service provider transmits the PAN number to the mobile operator in a message as denoted by message 201.

In a step 206 the mobile operator 102 then associates the ICCID number with the PAN number, and may generate a file identifying the link between the two numbers.

The mobile operator 102 then transmits the file identifying the link to the service provider in a message as denoted by message 203.

At this stage the link between the two unique identifiers has been established. Once the first and second identifier are linked, they become a pair, and if the linking is carried out by the mobile operator the mobile operator provides the information identifying the link to the service provider as noted above. Alternatively the service provider is aware of the link. The link between the first and second identifiers may be conveniently provided from the mobile operator to the service provider in a linking file.

Once the link is established, the SIM card and pay-as-you-go swipe card each need to be manufactured, and preferably presented for sale in such a way as they can only be purchased as a pair.

The service provider may utilise a third party manufacturer to manufacture the cards, and provides the link between the two unique numbers to the card manufacturer which manufactures cards in association with the service provider's specification. As shown in FIG. 2, the service provider transmits a link file identifying the link to the card manufacturer 106 as denoted by message 205.

The service provider's specification may vary, and the production of the cards may vary. However in accordance with the invention the service provider provides the manufacturer with the link, such that the manufacturer pairs SIM cards containing the first identification number with pay-as-you-go cards containing the second identification number.

The manufacturer pairs the cards in a way specified by the service provider. This may comprise the manufacturer manufacturing the two cards in a pair, connected by some form of perforated edging connector, or the manufacturer providing the separated cards in a single package. The specifics of the manifestation of the pairing are not important, and one skilled in the art will appreciate that the important aspect is that after manufacture the cards are paired and are offered for sale as a pair.

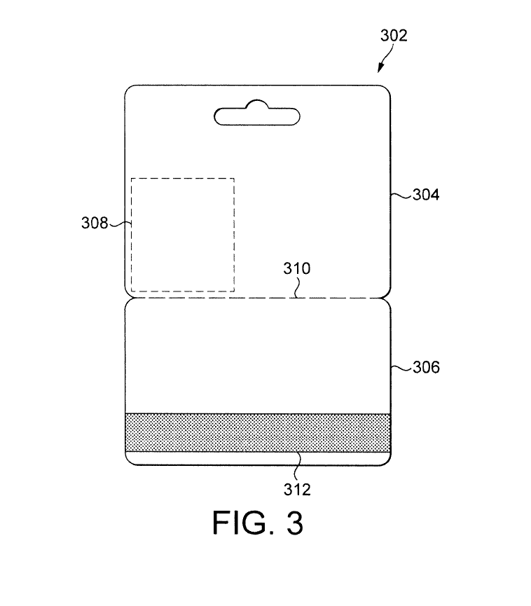

FIG. 3 illustrates an example of a paired SIM card and pay-as-you-go card which may be manufactured for a point-of-sale. A package 302 which may be displayed at a point-of-sale comprises a first part 304 which includes a ‘snap-out’ portion as denoted by the dashed line 308, comprising a SIM card. The first part 304 may be referred to as a housing portion for the SIM card 308. A housing portion may be provided due to the small size of the SIM card. A further portion 306 comprises the pay-as-you-go card which is connected to the part 304 such that it may be snapped off for further use, as denoted by the dashed line 310. The exemplary pay-as-you-go card illustrated is a swipe card, and shown in FIG. 3 is the magnetic portion 312 of the pay-as-you-go card 306, which is swiped at a point of sale.

The SIM card and the pay-as-you-go card may thus be physically connected together for sale. Alternatively, for example, the SIM card and the pay-as-you-go card may be contained in a wrapping such that they are presented as a single item for purchase at a point-of-sale.

After the cards are manufactured, as denoted by step 208, the card manufacturer may transmit an appropriate message to the service provider, as denoted by message 207.

The cards are then provided by the service provider to various point-of-sale locations of merchants, as denoted by message 209. Thus on sale are pairs of cards providing SIM cards and top-up cards, which have unique identifiers which have been pre-associated. Although only one point-of-sale is referred to for ease of explanation, it will be understood that the card pairs are in fact provided for sale in multiple points-of-sale. Step 210 denotes the offer-for-sale of card pairs.

A user may then purchase a suitably packaged card pair at a point-of-sale. Again, although only one user is described for ease of explanation, multiple users may purchase card pairs at any of multiple points-of-sale.

The purchase of a card pair by a user is illustrated by message 211 in FIG. 2, denoting an initiation of a purchase transaction by a user at a point-of-sale.

On purchasing, the merchant at the point of sale swipes the swipe section of the pay-as-you-go card (the magnetic strip 312 in FIG. 3) to activate the card pair, in the exemplary example the pay-as-you-go card being a swipe card. The swiping of the pay-as-you-go card is illustrated by step 212 in FIG. 2. The pay-as-you-go card is in general the point-of-sale activation card.

Responsive to the swiping of the pay-as-you go card, the point-of-sale apparatus transmits a top-up message to the service provider as denoted by message 213. In this example the message type is a top-up message. However the message may be of another type, and in general may be a message to ‘top-up’. The message may be just to ‘activate’ the SIM through the top-up mechanism. The ‘message’ may be such as to add additional features to the mobile account, not just to activate the SIM and/or top-up the account.

The service provider 104 then forwards an appropriate top-up message to the mobile operator as denoted by message 215.

The mobile operator accesses the link file associated with the PAN number of the top-up message, provided by the pay-as-you-go card. The PAN number then provides the link to the ICCID number of the SIM card.

The mobile operator 102 then activates the associated SIM card, as denoted by step 214, and applies the top-up of the pay-as-you-go card to the SIM card, as denoted by step 216.

The mobile operator then transmits a success message to the service provider 104, as denoted by message 217. The service provider 104 then transmits an appropriate success message to the point-of-sale apparatus, as denoted by message 219.

As denoted by step 218 the point-of-sale operation is then complete. The swipe operation (or other point-of-sale operation in accordance with the card technology, such as a scan operation) is acknowledged as successfully completed. The merchant operating the point-of-sale apparatus may hand the package to the user, as denoted by message 221, to finish the transaction, and the user receives an activated SIM card with an appropriate top-up applied to it.

Thus the SIM card is activated at the point-of-sale.

The description of FIG. 2 describes a particular exemplary implementation for the purpose of illustrating the invention and embodiments thereof. FIG. 2 does not, however, limit the invention to the operations as described. Various alternative modifications may be implemented. For example, it may be that the mobile operator does not know about the link until it receives a transaction from the service provider. The service provider may send the ICCID and PAN to the mobile operator when a purchase is made. In this scenario, the service provider creates PANs and does the linking to ICCIDs, and holds the linking information. The mobile operator only needs to know about the linking on occurrence of a sale at the point-of-sale. Before the sale, the mobile operator database may only contain the ICCID. Once a sale is completed, responsive to the message 213, the service provider may send the PAN and the link to the ICCID (or the linked ICCID) to the mobile operator so it can activate the SIM in step 214 and identify the link to apply the top-up in step 216.

The mobile operator may also be referred to as the network operator.

The location and date/time of the activation of the SIM card is known.

The purchased SIM card can then be used in a mobile telephone, and a credit is associated with the SIM straight away.

Any further top-up is automatically credited to that SIM card as the top-card is used.

The example above describes a scenario in which the card pair comprises a SIM card and a pay-as-you-go card. As noted above, the use of a pay-as-you go card is exemplary. The card pair is not limited to these specific types of card, and other types of card may be provided.

For example, the pay-as-you-go card may be replaced by a pre-paid card. As well as adding a top-up payment to the account associated with the SIM card on activation (e.g. when the magnetic stripe of the card is swiped), this action to activate the SIM card and apply a credit to the SIM card may also enable the pre-paid card. The card may then further be used as a pre-paid card, with value being added to it at various point-of-sale locations.

The pre-paid card may be considered as or referred to as a pre-paid credit card or a pre-paid debit card, i.e. a card that can be used like a credit card or debit card to make purchases at points-of-sale. However the pre-paid card can only be used if it has a card value associated with it which is equal to or greater than the value of the transaction being made. It can thus be used like a credit or debit card, but no credit is actually given or used.

The pre-paid card may have a value associated with it, which is the purchase value of the card pair. When purchased, that purchase value may be applied as a top-up value to the mobile account associated with the SIM, and the pre-paid card is then left with zero balance. The pre-paid card may then be credited with money, e.g. at an appropriate point-of-sale location thereafter, for further use as a pre-paid card.

The pre-paid card may have a value associated with it, which is the purchase value of the card pair. When purchased, part of that purchase value may be applied as a top-up value to the mobile account associated with the SIM, and the pre-paid card is then left with the remaining amount as a balance. The pre-paid card can then be used for further purchases, and further credited with money, e.g. at an appropriate point-of-sale location, thereafter.

In general part or all of the value for which the card pair is purchased may be applied to the mobile account associated with the SIM, and part or none of the value for which the card pair is purchased may be applied to the pre-paid card. The purchaser may be able to specify, at the point-of-sale, how the purchase value is to be used in terms of dividing it between a top-up payment to the mobile account and credit for the pre-paid card. When this option is provided, the top-up message 213 is suitably modified to convey this information.

The pre-paid card may be permanently associated with the mobile account associated with the SIM card. When the balance of the mobile account associated with the SIM card falls, after activation and subsequent use, equal to or below a threshold amount, a value may automatically be deducted from the pre-paid card and applied to the mobile account, provided the pre-paid card has that value as credit. A user may establish the threshold for the mobile account, and may establish the amount of credit to be transferred from the pre-paid card to the mobile account in the event that the threshold condition is met, and may establish that such action is performed provided a minimum value is retained on the pre-paid card.

It should be understood that the pre-paid card is associated with a pre-paid account, with which any value associated with the pre-paid card is associated. The SIM card is similarly associated with a mobile account, with any value associated with the SIM card being associated with the mobile account.

There may be provided a mechanism which allows value or credit associated with either the SIM card or the pre-paid card to be transferred therebetween. By virtue of the technique described in this description, the pre-paid card and the SIM card are linked together, and therefore their associated accounts are linked together. A user may therefore be able to transfer value (i.e. credit) from the pre-paid card account to the mobile account, or vice versa, based on this existing link between the two accounts. A user may thus be able to apply credit to the pre-paid account or to the mobile account without having to purchase credit elsewhere, for example at a point-of-sale.

An application may be provided, which a user can access, which can facilitate the transfer of credit between a pre-paid account and a mobile account in this way. The application may be a website which a user can log on to, or a so-called ‘app’ which a user may utilise. An ‘app’ may be an application running on a smartphone or tablet device which a user can use to facilitate the transfer of credit between the mobile account and the pre-paid account. The link between these accounts is predetermined by the link established at set-up, as described in the foregoing.

A user may also utilise an application to access either account, which allows credit to be applied to that account by taking payment from another account, such as but not limited to an account associated with a credit card or a debit card, or an account associated with another pre-paid card.

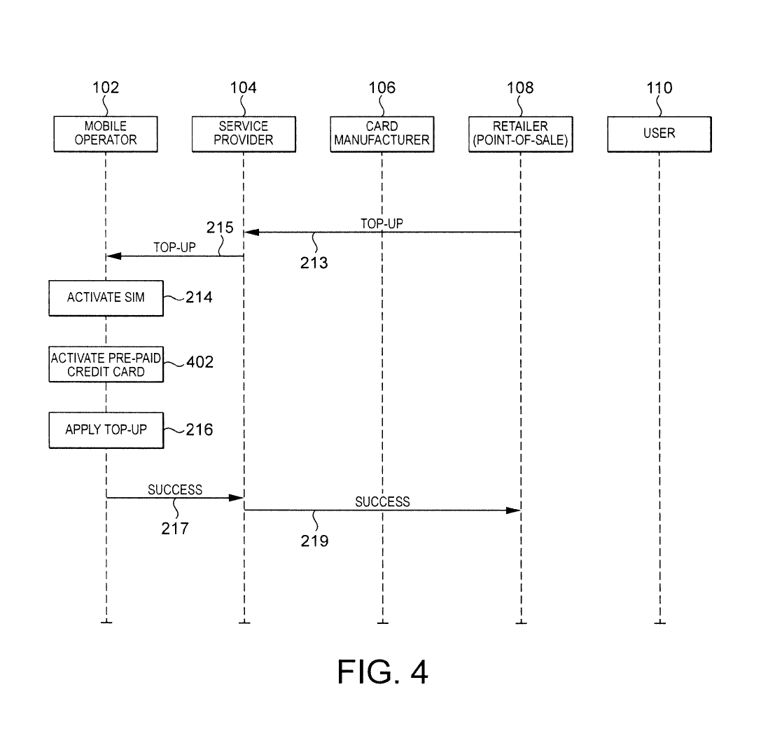

With reference to FIG. 4 there is illustrated a modification to the process of FIG. 2 in accordance with this arrangement. All aspects of the process of FIG. 2 remain the same, and with this arrangement an additional step is added. FIG. 2 is not reproduced in its entirety in FIG. 4, with only those parts being shown which allow the context of this arrangement to be understood. Where elements of FIG. 4 correspond to elements of FIG. 2, like reference numerals are used. It will be understood that those parts of FIG. 2 not shown in FIG. 4 are nevertheless part of the process of FIG. 4, both before and after the elements shown.

As can be seen in FIG. 4, the process proceeds as in FIG. 2 and after the top-up message 215 is received, the mobile operator 102 activates the SIM and applies the top-up in steps 214 and 216 respectively. In addition, the mobile operator activates the pre-paid card as denoted by step 402. As shown in FIG. 4, the mobile operator may activate the pre-paid credit in step 402, and then apply the top-up from the thus activated pre-paid credit-card in step 216. However the order of the activation and the application of the top-up may vary.

After the steps carried out by the mobile operator 102, the success message 217 is transmitted as before, and the process continues as before.

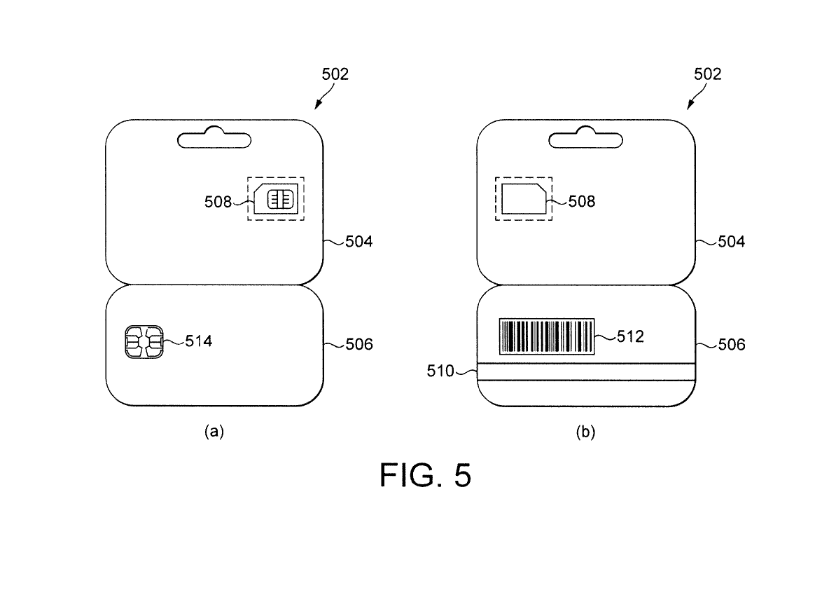

FIGS. 5(a) and 5(b) illustrate an example of a card pair package 502 comprising a card 504 housing a SIM card and a pre-paid card 506. FIG. 5(a) shows one side of the package and FIG. 5(b) shows the other side of the package. As in FIG. 3, the cards 504 and 506 may be detached from each other, which would then allow the pre-paid card 506 to be retained and used as a pre-paid card.

The card 504 includes a ‘snap-out’ SIM card denoted by reference numeral 508, which is visible on both sides of the card pair package as shown in FIGS. 5(a) and 5(b).

One side of the pre-paid card comprises a ‘chip’ 514 which is used to store card information, and used, for example, in ‘chip-and-pin’ purchases. This is shown in FIG. 5(a). The other side of the pre-paid card includes a magnetic stripe 510 and/or a barcode 512. The barcode may be provided on a hybrid pre-paid card. This is shown in FIG. 5(b).

Although the arrangement of FIGS. 5(a) and 5(b) illustrates a card pair, consistent with the arrangement of FIG. 3, as noted above the invention may utilise some pairing of devices other than cards. Either unique identifier may be provided on a device other than a card.

The invention has been described by way of implementation in an exemplary architecture, and by way of an exemplary process for pairing SIM and pay-as-you-go or pre-paid cards and activating the paired cards. One skilled in the art will appreciate that the invention may be applied to alternative architectures, and the invention may employ alternative processes for activation. The invention provides a scope of protection for alternative architectures and implementations which is determined by the scope of the appended claims.

1. A method of enabling a SIM circuit for a mobile telephone and associating an attribute to the SIM circuit, the method comprising:
associating a unique identifier of the SIM circuit with a unique identifier of the attribute;
retrieving an identity of one of the SIM circuit and the attribute at a point-of-sale;
transmitting a message including the retrieved identity;
responsive to the message, enabling the SIM circuit and applying the attribute to the SIM circuit.

2. The method of claim 1 wherein retrieving the identify of one of the SIM circuit and the attribute at the point-of-sale includes retrieving the associated unique identifier.

3. The method of claim 1 or claim 2 wherein the message includes an indication of the unique identifier.

4. The method of claim 3 wherein the message includes the unique identifier.

5. The method of any one of claims 1 to 4 wherein the step of retrieving the identity of one of the SIM circuit and the attribute at the point-of-sale includes swiping or scanning a device associated with the attribute.

6. The method of claim 5 wherein the message includes an indication of a unique identifier of a card associated with the attribute.

7. The method of any one of claims 1 to 6 wherein responsive to the message the SIM circuit associated with the attribute is identified, and the SIM circuit is enabled and the attribute applied to the SIM circuit.

8. The method of claim 7 further wherein the message is transmitted from the point-of-sale, and on enablement of the SIM circuit and application of the attribute a success message is transmitted to the point-of-sale.

9. The method of any one of claims 1 to 8 wherein the attribute is a value.

10. The method of any one of claims 1 to 9 wherein a card identifies the attribute.

11. The method of claim 10 wherein the card is a pay-as-you go or top-up card.

12. The method of claim 10 wherein the card is a pre-paid card.

13. The method of any one of claims 1 to 12 wherein the SIM circuit is provided on a SIM card.

14. The method of claim 13 when dependent on claim 11 or claim 12 further comprising manufacturing a SIM card and top-up payment or pre-paid card pair, and presenting such pair for purchase at the point-of-sale.

15. The method of any preceding claim further comprising transferring credit between an account associated with the SIM circuit and an account associated with the attribute based on the association.

16. A method substantially as described herein.

17. A method substantially as described herein, with reference to or as shown in the accompanying drawings.

18. A system for enabling a SIM circuit for a mobile telephone and associating an attribute to the SIM circuit, in which system a unique identifier of a SIM card is associated with a unique identifier of the attribute, the system comprising:
a point-of sale device for retrieving an identity of one of the SIM circuit and the attribute, and for transmitting a message including the retrieved identity to a network controller;
the network controller for enabling, on receipt of the message, the SIM circuit and applying the attribute to the SIM circuit.

19. The system of claim 18 wherein the point-of-sale device retrieves the associated unique identifier.

20. The system of claim 18 or claim 19 wherein the point-of-sale device transmits a message including an indication of the unique identifier.

21. The system of claim 20 wherein the point-of-sale device transmits a message including the unique identifier.

22. The system of any one of claims 18 to 21 wherein the point-of-sale device includes a device for scanning or swiping a card associated with the attribute.

23. The system of any one of claim 22 wherein the message includes an indication of the unique identifier of the card.

24. The system of any one of claims 18 to 23 wherein the message is transmitted from the point-of-sale device to the network controller, wherein the network controller identifies the SIM circuit associated with the attribute, and the network controller enables the SIM circuit and applies the attribute to the SIM circuit.

25. The system of claim 24 further wherein on enablement of the SIM circuit and application of the attribute a success message is transmitted from the network controller to the point-of-sale.

26. The system of any one of claims 18 to 25 further comprising a card identifying the attribute.

27. The system of claim 26 wherein the card is a top-up payment card.

28. The system of claim 26 wherein the card is a pre-paid card

29. The system of any one of claims 18 to 26 further comprising a SIM card including the SIM circuit.

30. The system of claim 29 when dependent on any one of claims 25 to 27 further comprising a manufacturing entity for manufacturing a card pair comprising the SIM card and the card identifying the attribute.

31. The system of any one of claims 18 to 30 wherein there is provided a mechanism for transferring credit between an account associated with the SIM circuit and an account associated with the attribute based on the association.

32. The system of claim 31 wherein the mechanism is facilitated by a software application.

33. A system substantially as described herein.

34. A system substantially as described herein, with reference to or as shown in the accompanying drawings.

35. A service provider entity of a mobile telephony system, in which system a unique identifier of a SIM circuit is associated with a unique identifier of an attribute, the service provider entity adapted to:
receive, from a point-of-sale, an identity of a device, associated with the attribute, retrieved at the point-of-sale;
forward the identity to an operator;
receive, from the operator, confirmation that the SIM circuit associated with the identified attribute is activated, and that the attribute has been applied to the SIM circuit; and
forward a confirmation to the point-of-sale.

36. The service provider entity of claim 35 further comprising a SIM card including the SIM circuit.

37. The service provider entity of claim 35 or claim 36 wherein the device is card.

38. The service provider of claim 37 wherein the attribute is a value, the card being associated with the value.

39. The service provider of claim 38 wherein the card is a top-up payment card.

40. The service provider of claim 38 wherein the card is a pre-paid card.

41. The service provider of any one of claims 35 to 40 further adapted to transfer credit between an account associated with the SIM circuit and an account associated with the attribute based on the association.

42. A service provider entity substantially as described herein.

43. A service provider entity substantially as described herein, with reference to or as shown in the accompanying drawings.

44. A method of enabling a SIM circuit of a mobile telephone and associating a unique identifier of the SIM circuit with a unique identifier of an attribute, the method comprising:
receiving, from a point-of-sale, an identity of a device, associated with the attribute, retrieved at the point-of-sale;
forwarding the identity to an operator;
receiving, from the operator, confirmation that the SIM circuit associated with the identified attribute is activated, and that the attribute has been applied to the SIM circuit; and
forwarding a confirmation to the point-of-sale.

45. A method for enabling a SIM circuit of a mobile telephone and associating an attribute to the SIM circuit, the method comprising:
linking unique identifiers of a plurality of SIM circuits with unique identifiers of a respective plurality of attributes;
manufacturing sets of SIM circuits and attribute devices, a set being determined by the link;
offering for sale the manufactured sets of SIM circuits and attribute devices;
on purchase of a set, retrieving an attribute identifier of the set at a point-of sale, and transmitting a message including an identification of the attribute identifier to a mobile network entity;
retrieving, at the mobile network entity, the identity of the linked SIM circuit in dependence on the identity of the attribute;
activating, at the mobile network entity, the SIM circuit;
applying, at the mobile network entity, the attribute to the SIM circuit;
transmitting a successful completion message from the mobile network entity to the point-of-sale apparatus.

46. A method according to claim 45 wherein the device is a card.

47. A method according to claim 46 wherein the attribute is a value associated with the card.

48. A method according to claim 46 or claim 47 wherein the card is a top-up card.

49. A method according to any one of claims 46 to 48 wherein the card is a pre-paid card.

50. A method according to claim any one of claims 46 to 49, wherein at least part of the value of the pre-paid card is the attribute applied to the SIM circuit.

51. A method according to claim any one of claims 46 to 49 wherein at least part of the value of the pre-paid card is retained as credit of the pre-paid card.

52. A method of any one of claims 49 to 51 further comprising activating the pre-paid card.

53. A method according to any one of claims 45 to 52 wherein the SIM circuit is provided as a SIM card.

54. A method according to any one of claims 45 to 53 further comprising transferring credit between an account for the SIM circuit and an account for the attribute based on said linking between the unique identifiers.

55. Apparatus for enabling a SIM circuit of a mobile telephone and associating an attribute to the SIM circuit, wherein unique identifiers of a plurality of SIM circuits are linked with unique identifiers of a respective plurality of attributes, the apparatus comprising:
a manufacturer for manufacturing sets of SIM circuits and attribute devices, a set being determined by the link;
merchants for offering for sale the manufactured sets of SIM circuits and attribute devices, and on purchase of a set, retrieving an attribute identifier of the set at a point-of sale, and transmitting a message including an identification of the attribute identifier;
a mobile network entity for receiving the message including the identification of the attribute identifier, and adapted to: retrieving, at the mobile network entity, the identity of the linked SIM circuit in dependence on the identity of the attribute; activating, at the mobile network entity, the SIM circuit; applying, at the mobile network entity, the attribute to the SIM circuit; and transmitting a successful completion message from the mobile network entity to the point-of-sale apparatus.

56. The apparatus of claim 55 wherein the attribute device is a card.

57. The apparatus of claim 56 wherein the attribute device is a card having a value to be applied as a credit to the SIM circuit.

58. The apparatus of claim 56 or claim 57 wherein the card is a pre-paid card.

59. The apparatus of claim 58 wherein the mobile network entity is adapted to activate the pre-paid card.

60. The apparatus if claim 58 or claim 59 wherein the pre-paid card is associated with a pre-paid account, and the attribute is associated with a mobile account linked to the SIM circuit, further wherein credit is transferred between the pre-paid account and the mobile account based on the linking of the unique identifiers.
